(19) United States
(12) Patent Application Publication
(10) Pub. No.: US 2026/0332230 A1
(43) Pub. Date: Oct. 22, 2026

(54) METHODS AND APPARATUS FOR ENHANCED BEAM ACQUISITION

(71) Applicant: QUALCOMM Incorporated, San Diego, CA (US)

(72) Inventors: Yi HUANG, San Jose, CA (US); Jun ZHU, San Diego, CA (US); Mihir Vijay LAGHATE, San Diego, CA (US); Ruhua HE, San Diego, CA (US); Ting KONG, San Diego, CA (US); Rahul MALIK, San Diego, CA (US); Raghu Narayan CHALLA, San Diego, CA (US)

(21) Appl. No.: 19/183,714

(22) Filed: Apr. 18, 2025

(51) Int. Cl. H04B 7/06; H04W 74/0833

(52) U.S. Cl. CPC H04B 7/06952; H04W 74/0833

(57) ABSTRACT

Aspects of the present disclosure include methods, apparatuses, and computer readable media for transmitting a plurality of level 1 (L1) beams, receiving, in response to transmitting the plurality of L1 beams, a plurality of L1 beam responses indicating a plurality of L1 beam qualities associated with the plurality of L1 beams, providing the plurality of L1 beam qualities to a predictor configured to predict one or more beam configurations, receiving a first level 4 (L4) beam configuration predicted by the predictor based on the plurality of L1 beam qualities, transmitting a first L4 beam based on the L4 beam configuration, receiving, in response to transmitting the first L4 beam, a first L4 beam response indicating a first L4 beam quality, the first L4 beam quality being less than a L4 beam threshold.

### BACKGROUND

Aspects of the present disclosure relate generally to wireless communications, and more particularly, to apparatuses and methods for enhanced beam acquisition.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

In a wireless communication network, a wireless device may perform a beam sweep to identify a beam for transmission and/or reception. Each beam may be associated with a different antenna configuration and/or direction. Without a proper beam sweep, the throughput and/or reliability of wireless communication may be too low to support many applications. In order to identify a desired beam for communication, the wireless device may traverse through many beams. However, the quantity of beams configurations may be large, and a complete beam sweep (testing every beam configuration available) may take a prohibitively long time. As such, improvements in beam sweep may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include methods for performing beam sweep including transmitting a plurality of level 1 (L1) beams, receiving, in response to the transmitting the plurality of L1 beams, a plurality of L1 beam responses indicating a plurality of L1 beam qualities associated with the plurality of L1 beams, providing the plurality of L1 beam qualities to a predictor configured to predict one or more beam configurations, receiving a first level 4 (L4) beam configuration predicted by the predictor based on the plurality of L1 beam qualities, transmitting a first L4 beam based on the L4 beam configuration, receiving, in response to transmitting the first L4 beam, a first L4 beam response indicating a first L4 beam quality, the first L4 beam quality being less than a L4 beam threshold, providing the plurality of L1 beam qualities and the first L4 beam quality to the predictor, receiving a second L4 beam configuration predicted by the predictor based on the plurality of L1 beam qualities and the first L4 beam quality, transmitting a second L4 beam based on the second L4 beam configuration, and receiving, in response to transmitting the second L4 beam, a second L4 beam response indicating a second L4 beam quality.

An aspect of the present disclosure includes a transmitter for performing beam sweep including means for transmitting a plurality of level 1 (L1) beams, means for receiving, in response to transmitting the plurality of L1 beams, a plurality of L1 beam responses indicating a plurality of L1 beam qualities associated with the plurality of L1 beams, means for providing the plurality of L1 beam qualities to a predictor configured to predict one or more beam configurations, means for receiving a first level 4 (L4) beam configuration predicted by the predictor based on the plurality of L1 beam qualities, means for transmitting a first L4 beam based on the L4 beam configuration, means for receiving, in response to transmitting the first L4 beam, a first L4 beam response indicating a first L4 beam quality, the first L4 beam quality being less than a L4 beam threshold, means for providing the plurality of L1 beam qualities and the first L4 beam quality to the predictor, means for receiving a second L4 beam configuration predicted by the predictor based on the plurality of L1 beam qualities and the first L4 beam quality, means for transmitting a second L4 beam based on the second L4 beam configuration, and means for receiving, in response to transmitting the second L4 beam, a second L4 beam response indicating a second L4 beam quality.

Aspects of the present disclosure includes a transmitter including one or more memories configured to store executable instructions, one or more processors communicatively coupled to the one or more memories and configured to execute the stored executable instructions to: transmit a plurality of level 1 (L1) beams, receive, in response to transmitting the plurality of L1 beams, a plurality of L1 beam responses indicating a plurality of L1 beam qualities associated with the plurality of L1 beams, provide the plurality of L1 beam qualities to a predictor configured to predict one or more beam configurations, receive a first level 4 (L4) beam configuration predicted by the predictor based on the plurality of L1 beam qualities, transmit a first L4 beam based on the L4 beam configuration, receive, in response to transmitting the first L4 beam, a first L4 beam response indicating a first L4 beam quality, the first L4 beam quality being less than a L4 beam threshold, provide the plurality of L1 beam qualities and the first L4 beam quality to the predictor, receive a second L4 beam configuration predicted by the predictor based on the plurality of L1 beam qualities and the first L4 beam quality, transmit a second L4 beam based on the second L4 beam configuration, and receive, in response to transmitting the second L4 beam, a second L4 beam response indicating a second L4 beam quality.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system and an access network according to aspects of the present disclosure.

FIG. 2 is a schematic diagram of an example of a user equipment according to aspects of the present disclosure.

FIG. 3 is a schematic diagram of an example of a base station according to aspects of the present disclosure.

FIG. 4 is a block diagram of an example of a first beam sweep scheme according to aspects of the present disclosure.

FIG. 5 is a block diagram of an example of a second beam sweep scheme according to aspects of the present disclosure.

FIG. 6 is a block diagram of a beam sweep scheme using LFS according to aspects of the present disclosure.

FIG. 7 is a block diagram of a beam sweep scheme using FFS according to aspects of the present disclosure.

FIGS. 8A-B are a flow diagram of a method of performing beam sweep according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

Prior to communicating with a remote wireless device, a transmitter may perform a beam sweep to identify the beam for use in the wireless communication (transmitting and/or receiving signals). A full frequency scan (scanning all raster for different bands) may be time consuming. However, a list frequency scan (scanning a limited number of frequencies) may fail to identify a beam that is sufficient to support the wireless communication. As such, aspects of the present disclosure includes using machine learning to select one or more beams for the beam sweep.

Aspects of the present disclosure may relate to enhanced beam acquisition. For instance, in an aspect, the transmitter may transmit a number of level 1 (L1) beams to the receiver. The transmitter may receive a number of responses associated with the L1 beams. The number of responses may indicate the beam qualities of the number of L1 beams. If the L1 beams are insufficient for transmission (e.g., the reference signal received power (RSRP) values of the L1 beams are lower than a threshold, the signal-to-noise (SNR) ratio is higher than a different threshold, etc.), the transmitter may provide the beam qualities of the number of L1 beams to a neural network. The neural network may provide a L4 beam configuration to the transmitter based on the beam qualities of the L1 beams. Consequently, the transmitter may transmit a L4 beam based on the L4 beam configuration provided by the neural network to gauge the quality of the transmission.

The transmitter transmit a number of level 2 (L2) beams to the receiver. The transmitter may receive a number of responses associated with the L2 beams. The number of responses may indicate the beam qualities of the number of L2 beams. If the L2 beams are insufficient for transmission (e.g., the reference signal received power (RSRP) values of the L1 beams are lower than a threshold), the transmitter may provide the beam qualities of the number of L2 beams to the neural network. The neural network may provide a L4 beam configuration to the transmitter based on the beam qualities of the L2 beams. Consequently, the transmitter may transmit a L4 beam based on the L4 beam configuration provided by the neural network to gauge the quality of the transmission.

The enhanced beam acquisition techniques described herein can improve the selection of beams used for communication based on both prediction and measured beam qualities. For example, selection of a better beam may improve RSRP and/or SNR such that transmissions have a lower error rate and/or a data rate (e.g., modulation and coding scheme (MCS) can be improved. Accordingly, improved quality of experience may be observed in the form of lower latency and higher throughput.

The transmitter may be a base station (BS), a user equipment (UE), and/or a customer premise equipment (CPE). Similarly, the receiver may be a BS, a UE, and/or a CPE.

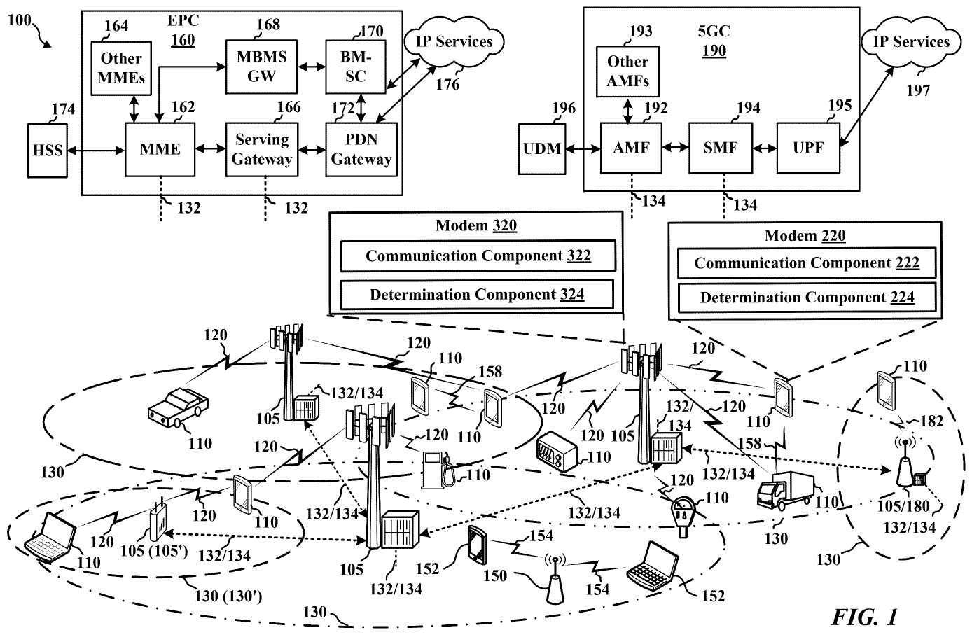

FIG. 1 is a diagram illustrating an example of a wireless communications system and an access network 100. The wireless communications system (also referred to as a wireless wide area network (WWAN)) includes at least one BS 105, UEs 110, an Evolved Packet Core (EPC) 160, and a 5G Core (5GC) 190. The BS 105 may include macro cells (high power cellular base station) and/or small cells (low power cellular base station). The macro cells include base stations. The small cells include femtocells, picocells, and microcells. In one implementation, the UE 110 may include a communication component 222 configured to communicate with the BS 105 via a cellular network, a Wi-Fi network, or other wireless and wired networks. The UE 110 may include a determination component 224 configured to determine whether a beam quality is greater than or equal to, or less than, a beam threshold. In some implementations, the communication component 222 and/or the determination component 224 may be implemented using hardware, software, or a combination of hardware and software. In some implementations, the BS 105 may include a communication component 322 configured to communicate with the UE 110. The BS 105 may include a determination component 324 configured to determine whether a beam quality is greater than or equal to, or less than, a beam threshold. In some implementations, the communication component 322 and/or the determination component 324 may be implemented using hardware, software, or a combination of hardware and software.

A BS 105 configured for 4G Long-Term Evolution (LTE) (collectively referred to as Evolved Universal Mobile Telecommunications System (UMTS) Terrestrial Radio Access Network (E-UTRAN)) may interface with the EPC 160 through backhaul links interfaces 132 (e.g., S1, X2, Internet Protocol (IP), or flex interfaces). A BS 105 configured for 5G NR (collectively referred to as Next Generation RAN (NG-RAN)) may interface with 5GC 190 through backhaul links interfaces 134 (e.g., S1, X2, Internet Protocol (IP), or flex interface). In addition to other functions, the BS 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The BS 105 may communicate directly or indirectly (e.g., through the EPC 160 or 5GC 190) with each other over the backhaul links interfaces 134. The backhaul links 132, 134 may be wired or wireless.

The BS 105 may wirelessly communicate with the UEs 110. Each of the BS 105 may provide communication coverage for a respective geographic coverage area 130. There may be overlapping geographic coverage areas 130. For example, the small cell 105′ may have a coverage area 130′ that overlaps the coverage area 130 of one or more macro BS 105. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the BS 105 and the UEs 110 may include uplink (UL) (also referred to as reverse link) transmissions from a UE 110 to a BS 105 and/or downlink (DL) (also referred to as forward link) transmissions from a BS 105 to a UE 110. The communication links 120 may use multiple-input and multiple-output (MIMO) antenna technology, including spatial multiplexing, beamforming, and/or transmit diversity. The communication links may be through one or more carriers. The BS 105/UEs 110 may use spectrum up to Y MHz (e.g., 5, 10, 15, 20, 100, 400, etc. MHz) bandwidth per carrier allocated in a carrier aggregation of up to a total of Yₓ MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 105′ may operate in a licensed and/or an unlicensed frequency spectrum. When operating in an unlicensed frequency spectrum, the small cell 105′ may employ NR and use the same 5 GHz unlicensed frequency spectrum as used by the Wi-Fi AP 150. The small cell 105′, employing NR in an unlicensed frequency spectrum, may boost coverage to and/or increase capacity of the access network.

A BS 105, whether a small cell 105′ or a large cell (e.g., macro base station), may include an eNB, gNodeB (gNB), or other type of base station. Some base stations, such as gNB 180 may operate in one or more frequency bands within the electromagnetic spectrum. The electromagnetic spectrum is often subdivided, based on frequency/wavelength, into various classes, bands, channels, etc. In 5G NR two initial operating bands have been identified as frequency range designations FR1 (410 MHz 7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW/near mmW radio frequency band has extremely high path loss and a short range. The mmW base station 180 may utilize beamforming 182 with the UE 110 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 110 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a packet switched (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the BS 105 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The BS 105 may also be referred to as a gNB, Node B, evolved Node B (eNB), an access point, a base transceiver station, a radio base station, an access point, an access node, a radio transceiver, a NodeB, eNodeB (eNB), gNB, Home NodeB, a Home eNodeB, a relay, a transceiver function, a basic service set (BSS), an extended service set (ESS), a transmit reception point (TRP), or some other suitable terminology. The BS 105 provides an access point to the EPC 160 or 5GC 190 for a UE 110. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.). The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

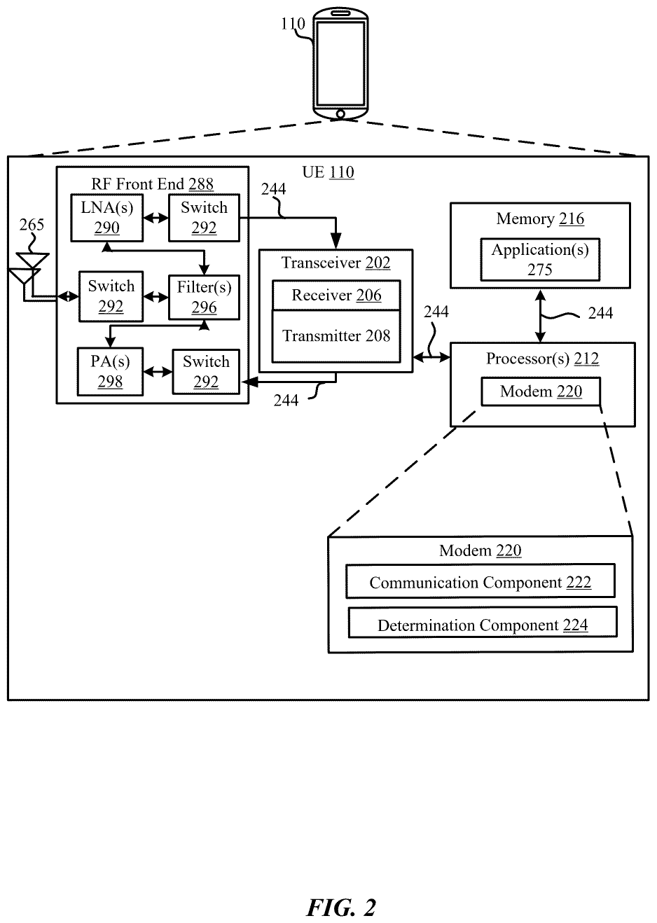

Referring to FIG. 2, one example of an implementation of the UE 110 may include a modem 220 having the communication component 222 and/or the determination component 224. In one implementation, the UE 110 may include a communication component 222 configured to communicate with the BS 105 via a cellular network, a Wi-Fi network, or other wireless and wired networks. The UE 110 may include a determination component 224 configured to determine whether a beam quality is greater than or equal to, or less than, a beam threshold.

In some implementations, the UE 110 may include a variety of components, including components such as one or more processors 212 and one or more memories 216 and transceiver 202 in communication via one or more buses 244, which may operate in conjunction with the modem 220 and the communication component 222 to enable one or more of the functions described herein related to communicating with the BS 105. Further, the one or more processors 212, modem 220, one or more memories 216, transceiver 202, RF front end 288 and one or more antennas 265, may be configured to support voice and/or data calls (simultaneously or non-simultaneously) in one or more radio access technologies. The one or more antennas 265 may include one or more antennas, antenna elements and/or antenna arrays.

In an aspect, the one or more processors 212 may include the modem 220 that uses one or more modem processors. The various functions related to the communication component 222 and/or the determination component 224 may be included in the modem 220 and/or processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiving device processor, or a transceiver processor associated with transceiver 202. Additionally, the modem 220 may configure the UE 110 along with the processors 212. In other aspects, some of the features of the one or more processors 212 and/or the modem 220 associated with the communication component 222 may be performed by transceiver 202.

The one or more memories 216 may be configured to store data used and/or local versions of application 275. Also, the one or more memories 216 may be configured to store data used herein and/or local versions of the communication component 222 and/or the determination component 224, and/or one or more of the subcomponents being executed by one or more processors 212. One or more memories 216 may include any type of computer-readable medium usable by a computer or one or more processors 212, such as random access memory (RAM), read only memory (ROM), tapes, magnetic discs, optical discs, volatile memory, non-volatile memory, and any combination thereof. In an aspect, for example, one or more memories 216 may be a non-transitory computer-readable storage medium that stores one or more computer-executable codes defining the communication component 222 and/or the determination component 224, and/or one or more of the subcomponents, and/or data associated therewith, when UE 110 is operating one or more processors 212 to execute the communication component 222 and/or the determination component 224, and/or one or more of the subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a RF receiving device. In an aspect, the receiver 206 may receive signals transmitted by at least one BS 105. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 110 may include RF front end 288, which may operate in communication with one or more antennas 265 and transceiver 202 for receiving and transmitting radio transmissions, for example, wireless communications transmitted by at least one BS 105 or wireless transmissions transmitted by UE 110. RF front end 288 may be coupled with one or more antennas 265 and may include one or more low-noise amplifiers (LNAs) 290, one or more switches 292, one or more power amplifiers (PAs) 298, and one or more filters 296 for transmitting and receiving RF signals.

In an aspect, LNA 290 may amplify a received signal at a desired output level. In an aspect, each LNA 290 may have a specified minimum and maximum gain values. In an aspect, RF front end 288 may use one or more switches 292 to select a particular LNA 290 and the specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and the specified gain value based on a desired gain value for a particular application.

Also, for example, one or more filters 296 may be used by RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, RF front end 288 may use one or more switches 292 to select a transmit or receive path using a specified filter 296, LNA 290, and/or PA 298, based on a configuration as specified by transceiver 202 and/or one or more processors 212.

As such, transceiver 202 may be configured to transmit and receive wireless signals through one or more antennas 265 via RF front end 288. In an aspect, transceiver may be tuned to operate at specified frequencies such that UE 110 may communicate with, for example, one or more BS 105 or one or more cells associated with one or more BS 105. In an aspect, for example, the modem 220 may configure transceiver 202 to operate at a specified frequency and power level based on the UE configuration of the UE 110 and the communication protocol used by the modem 220.

In an aspect, the modem 220 may be a multiband-multimode modem, which may process digital data and communicate with transceiver 202 such that the digital data is sent and received using transceiver 202. In an aspect, the modem 220 may be multiband and be configured to support multiple frequency bands for a specific communications protocol. In an aspect, the modem 220 may be multimode and be configured to support multiple operating networks and communications protocols. In an aspect, the modem 220 may control one or more components of UE 110 (e.g., RF front end 288, transceiver 202) to enable transmission and/or reception of signals from the network based on a specified modem configuration. In an aspect, the modem configuration may be based on the mode of the modem and the frequency band in use. In another aspect, the modem configuration may be based on UE configuration information associated with UE 110 as provided by the network.

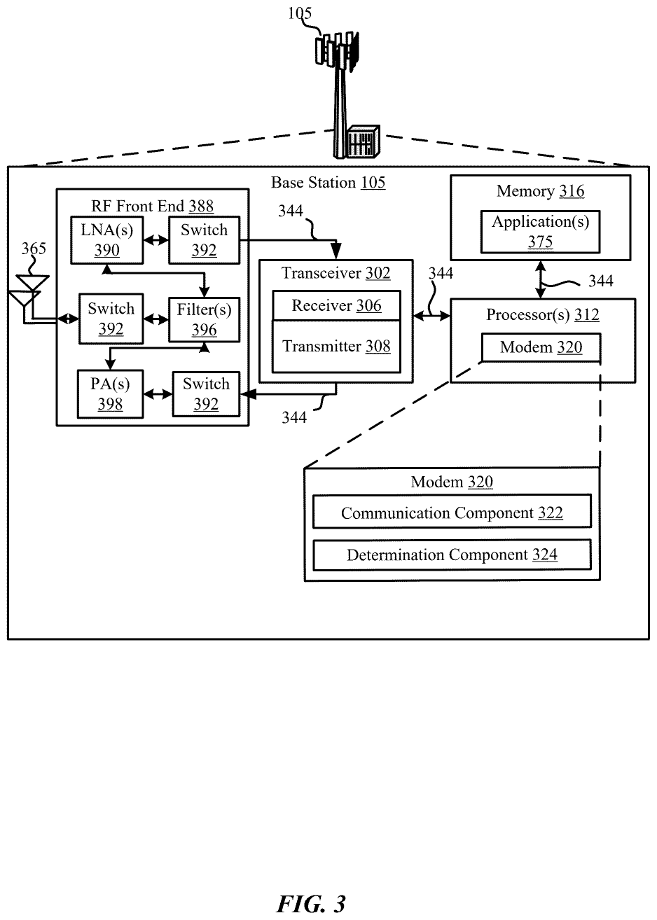

Referring to FIG. 3, one example of an implementation of the BS 105 may include a modem 320 having the communication component 322 and/or the determination component 324. In some implementations, the BS 105 may include a communication component 322 configured to communicate with the UE 110. The BS 105 may include the determination component 324 configured to determine whether a beam quality is greater than or equal to, or less than, a beam threshold.

In some implementations, the BS 105 may include a variety of components, including components such as one or more processors 312 and one or more memories 316 and transceiver 302 in communication via one or more buses 344, which may operate in conjunction with the modem 320 and the communication component 322 to enable one or more of the functions described herein related to communicating with the UE 110. Further, the one or more processors 312, modem 320, one or more memories 316, transceiver 302, RF front end 388 and one or more antennas 365, may be configured to support voice and/or data calls (simultaneously or non-simultaneously) in one or more radio access technologies.

In an aspect, the one or more processors 312 may include the modem 320 that uses one or more modem processors. The various functions related to the communication component 322 and/or the determination component 324 may be included in the modem 320 and/or processors 312 and, in an aspect, may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiving device processor, or a transceiver processor associated with transceiver 302. Additionally, the modem 320 may configure the BS 105 and processors 312. In other aspects, some of the features of the one or more processors 312 and/or the modem 320 associated with the communication component 322 may be performed by transceiver 302.

The one or more memories 316 may be configured to store data used herein and/or local versions of applications 375. Also, the one or more memories 316 may be configured to store data used herein and/or local versions of the communication component 322 and/or the determination component 324, and/or one or more of the subcomponents being executed by one or more processors 312. One or more memories 316 may include any type of computer-readable medium usable by a computer or one or more processors 312, such as random access memory (RAM), read only memory (ROM), tapes, magnetic discs, optical discs, volatile memory, non-volatile memory, and any combination thereof. In an aspect, for example, one or more memories 316 may be a non-transitory computer-readable storage medium that stores one or more computer-executable codes defining the communication component 322 and/or the determination component 324, and/or one or more of the subcomponents, and/or data associated therewith, when the BS 105 is operating one or more processors 312 to execute the communication component 322 and/or the determination component 324, and/or one or more of the subcomponents.

Transceiver 302 may include at least one receiver 306 and at least one transmitter 308. The at least one receiver 306 may include hardware, firmware, and/or software code executable by a processor for receiving data, the code comprising instructions and being stored in a memory (e.g., computer-readable medium). The receiver 306 may be, for example, a RF receiving device. In an aspect, receiver 306 may receive signals transmitted by the UE 110. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, the BS 105 may include RF front end 388, which may operate in communication with one or more antennas 365 and transceiver 302 for receiving and transmitting radio transmissions, for example, wireless communications transmitted by other BS 105 or wireless transmissions transmitted by UE 110. RF front end 388 may be coupled with one or more antennas 365 and may include one or more low-noise amplifiers (LNAs) 390, one or more switches 392, one or more power amplifiers (PAs) 398, and one or more filters 396 for transmitting and receiving RF signals.

In an aspect, LNA 390 may amplify a received signal at a desired output level. In an aspect, each LNA 390 may have a specified minimum and maximum gain values. In an aspect, RF front end 388 may use one or more switches 392 to select a particular LNA 390 and the specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and the specified gain value based on a desired gain value for a particular application.

Also, for example, one or more filters 396 may be used by RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, RF front end 388 may use one or more switches 392 to select a transmit or receive path using a specified filter 396, LNA 390, and/or PA 398, based on a configuration as specified by transceiver 302 and/or one or more processors 312.

As such, transceiver 302 may be configured to transmit and receive wireless signals through one or more antennas 365 via RF front end 388. In an aspect, transceiver may be tuned to operate at specified frequencies such that BS 105 may communicate with, for example, the UE 110 or one or more cells associated with one or more BS 105. In an aspect, for example, the modem 320 may configure transceiver 302 to operate at a specified frequency and power level based on the base station configuration of the BS 105 and the communication protocol used by the modem 320.

In an aspect, the modem 320 may be a multiband-multimode modem, which may process digital data and communicate with transceiver 302 such that the digital data is sent and received using transceiver 302. In an aspect, the modem 320 may be multiband and be configured to support multiple frequency bands for a specific communications protocol. In an aspect, the modem 320 may be multimode and be configured to support multiple operating networks and communications protocols. In an aspect, the modem 320 may control one or more components of the BS 105 (e.g., RF front end 388, transceiver 302) to enable transmission and/or reception of signals from the network based on a specified modem configuration. In an aspect, the modem configuration may be based on the mode of the modem and the frequency band in use. In another aspect, the modem configuration may be based on base station configuration associated with the BS 105.

In some aspects, a transmitter may perform a beam sweep to identify the beam for transmission and/or reception. To perform beam sweep, the transmitter may perform a list frequency scan (LFS) and/or a full frequency scan (FFS). For LFS, there are limited frequencies to scan, where the frequency list may be from CPE setup relating to a variety of factors, for example smartphone apps, operators, user, or technician input, and/or camping history. LFS may support early stop for the frequency search process before completing searching all frequencies. In some aspects, LFS may include attempt camping starting from the best cell. For FFS, the transmitter may scan all raster for different bands. There may be no frequency sorting across frequencies. Once acquisition success for a frequency is achieved, the FFS scheme may continue on the frequency for system information block (SIB) decoding and paging.

In an aspect, the transmitter may perform a hierarchical search to sweep multiple L1 and L2 beam levels for the CPE. In some cases, 7 L1 beams and 19 L2 beams may be swept. Additionally or alternatively, 61 level 3 (L3) beams and/or 155 level 4 (L4) beams may be swept. As beam level increases (from L1 to L4), more elements are used for beam forming, and the beam width becomes narrower. In a beam level early exit scheme for the physical layer, the transmitter may skip the remaining beams for current frequency binning. In a binning level early exit scheme, the transmitter may skip remaining frequency binning for the current raster, and send the measurement results to radio resource configuration (RRC).

However, existing beam acquisition may be time-consuming for both LFS and FFS. Per raster, the transmitter may sweep all L1 beams and L2 beams, and frequency bins, before report to RRC for CPE. Further, the transmitter may sweep all L1 beams and frequency bins for UE, unless beam and/or binning level early exit is met with RSRP/SNR measurements.

In one aspect of the present disclosure, obtaining a promising measurement of a L4 beam for CPE rather than relying on L2 beam measurements and/or blindly searching various L4 beam may reduce initial acquisition time and/or extend coverage. In some aspects, the UE may leverage the scheme in CPE, and the gain may cause beam and/or binning early exit sooner.

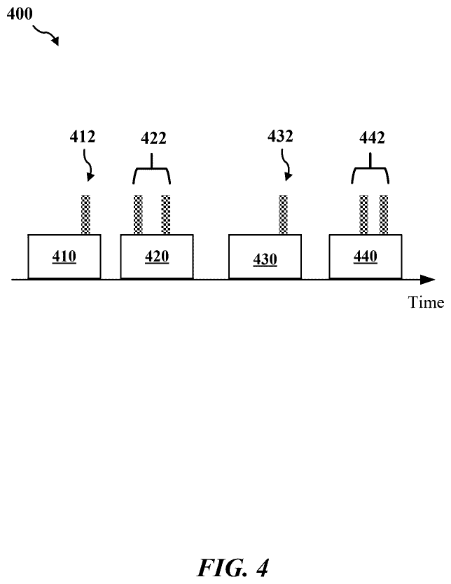

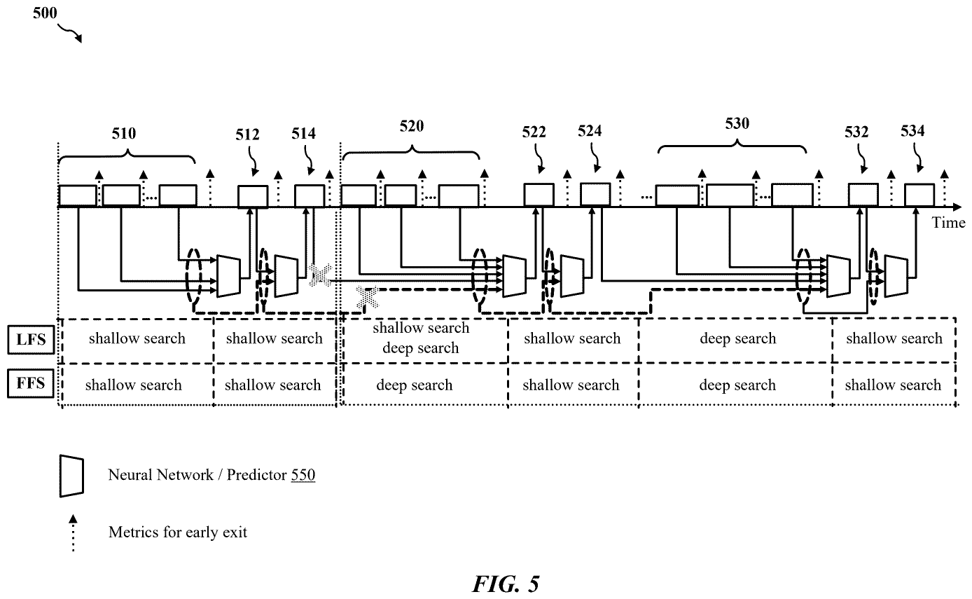

FIG. 4 is a block diagram of an example of a first beam sweep scheme 400 according to various aspects of the present disclosure. One aspect of the present disclosure may include using machine learning based range extension (MLRE) to predict L4 beams based on inferences. For example, the quality of the beams may be determined based on the RSRP and/or the SNR of the beam. Other factors and/or parameters may also be used by the predictor to infer and/or predict the next L4 beam according to an aspect of the present disclosure.

In one aspect, during a beam sweep, a transmitter, such as the BS 105 or the UE 110 (FIG. 1), may perform a shallow search or a deep search. A shallow search may include the transmitter transmitting one synchronization signal block for repetitive physical synchronization signal detection and one synchronization signal block for physical broadcast channel decoding. A deep search may include the transmitter transmitting multiple synchronization signal blocks for repetitive physical synchronization signal detection and multiple synchronization signal blocks for physical broadcast channel decoding. In one example, a deep search by the transmitter may include the transmitter transmitting three synchronization signal blocks for repetitive physical synchronization signal detection and three synchronization signal blocks for physical broadcast channel decoding.

In some aspects of the present disclosure, the transmitter may perform a LFS using MLRE. The transmitter may transmit a number of L1 beams 410 using a shallow search. The transmitter may provide the measured qualities of the L1 beams 410 to a neural network (not shown) to perform MLRE. In response, the neural network (or a predictor) may predict a L4 beam 412 based on the measured qualities of the L1 beams 410. In an aspect, the predictor may use the measured qualities of the L1 beams 410 and/or the L4 beams 412 to perform MLRE to generate additional L4 beams.

In another aspect, the transmitter may transmit a number of L2 beams 420 using a deep search. The transmitter may provide the measure qualities of the L2 beams 420 to the neural network to perform MLRE. In response, the neural network/predictor may predict L4 beams 422 based on the measured qualities of the L2 beams 420. In some aspects, the predictor may use the measured qualities of the L1 beams 410, the L2 beams 420, and/or the L4 beams 412, 422, to generate additional L4 beams.

In some aspects, the transmitter may perform an FFS using MLRE. The transmitter may transmit a number of L1 beams 430 using a shallow search. The transmitter may provide the measured qualities of the L1 beams 430 to the neural network to perform MLRE. In response, the neural network (or the predictor) may predict a L4 beam 432 based on the measured qualities of the L1 beams 430. In an aspect, the predictor may use the measured qualities of the L1 beams 430 and/or the L4 beams 432 to perform MLRE to generate additional L4 beams.

In certain aspects, the transmitter may transmit a number of L2 beams 440 using a deep search. The transmitter may provide the measure qualities of the L2 beams 440 to the neural network to perform MLRE. In response, the neural network/predictor may predict L4 beams 442 based on the measured qualities of the L2 beams 440. In some aspects, the predictor may use the measured qualities of the L1 beams 430, the L2 beams 440, and/or the L4 beams 432, 442, to generate additional L4 beams.

FIG. 5 is a block diagram of an example of a second beam sweep scheme 500 according to various aspects of the present disclosure. The second beam sweep scheme 500 may include the transmitter transmitting various beams to a receiver. The receiver may respond with a response indicating the qualities of the transmitted beams. In some aspects, the qualities of the transmitted beams may be indicated by the RSRP of the beams, the received signal strength indicator (RSRI) of the beams, the SNR of the beams, the signal to noise-interference ratio (SNIR) of the beams, or other factors known to one skilled in the art. In some aspects, the qualities of the transmitted beams may be indicated by a combination of the factors shown above. If the quality of a beam is greater than or equal to a predetermined threshold, the transmitter may perform an early exit and stop beam sweep. If the quality of a beam is less than a predetermined threshold, the transmitter may continue with the beam sweep as described below. In FIG. 5, the dashed arrows may indicate times for evaluating metrics for early exit.

In some aspects of the present disclosure, the transmitter may transmit L1 beams 510 to the receiver. Here, the transmitter may transmit the L1 beams 510 using shallow search for LFS and FFS. If any of the beam qualities of the L1 beams 510 is greater than or equal to a L1 beam threshold associated with the L1 beams 510, the transmitter may perform an early exit and/or begin initiating a communication session with the receiver. For example, the transmitter may begin a physical random access channel (PRACH) process using the L1 beam with the best beam quality (which may be the L1 beam having a beam quality that is greater than or equal to the L1 beam threshold). If the beam qualities of the L1 beams 510 are less than the L1 beam threshold, the transmitter may provide the beam qualities information of the L1 beams 510 to the neural network (also known as the predictor 550). The predictor 550 may generate a L4 beam configuration associated with a L4 beam 512 based on the beam qualities of the L1 beams 510.

In an aspect of the present disclosure, the transmitter may transmit the L4 beam 512. The transmitter may transmit the L4 beam 512 using shallow search for LFS and FFS. If the beam quality of the L4 beam 512 is greater than or equal to a L4 beam threshold associated with the L4 beam 512, the transmitter may perform an early exit as explained above. If the beam quality of the L4 beam 512 is less than the L4 beam threshold, the transmitter may provide the beam qualities information of the L1 beams 510 and the beam qualities information of the L4 beam to the predictor 550. The predictor 550 may generate a L4 beam configuration associated with a L4 beam 514 based on the beam qualities of the L1 beams 510 and the L4 beam 512.

In some aspects, the transmitter may transmit the L4 beam 514. The transmitter may transmit the L4 beams 514 using shallow search for LFS and FFS. If the beam quality of the L4 beam 514 is greater than or equal to the L4 beam threshold, the transmitter may perform an early exit as explained above. If the beam quality of the L4 beam 514 is less than the L4 beam threshold, the transmitter may transmit L2 beams 520 to continue the beam sweep process. The L2 beams 520 may be associated with the best L1 beam (e.g., highest RSRP/RSRI, lowest SNR/SNIR, etc.) of the L1 beams 510. In other words, the L2 beams 520 may be the children beams of the best L1 beam. Here, the transmitter may transmit the L2 beams 520 using shallow search for LFS because the L2 beams 520 are the children beams of the best L1 beam. The transmitter may transmit the L2 beams 520 using deep search for FFS. If any of the beam qualities of the L2 beams 520 is greater than or equal to a L2 beam threshold associated with the L2 beams 520, the transmitter may perform an early exit as explained above. If the beam qualities of the L2 beams 520 are less than the L2 beam threshold, the transmitter may provide the beam qualities information of the L2 beams 520, and optionally one or more of the beam qualities information of the L1 beams 510 and the L4 beams 512, 514, to the predictor 550. The predictor 550 may generate a L4 beam configuration associated with a L4 beam 522 based on the beam qualities of at least the L2 beams 520.

In some aspects of the present disclosure, the transmitter may transmit the L4 beam 522. The transmitter may transmit the L4 beams 522 using shallow search for LFS and FFS. If the beam quality of the L4 beam 522 is greater than or equal to the L4 beam threshold, the transmitter may perform an early exit as explained above. If the beam quality of the L4 beam 522 is less than the L4 beam threshold, the transmitter may provide the beam qualities information of L2 beams 520 and the L4 beam 522 to the predictor 550. The predictor 550 may generate a L4 beam configuration associated with a L4 beam 524 based on the beam qualities of the L2 beams 520 and the L4 beam 522.

In certain aspects of the present disclosure, the transmitter may transmit the L4 beam 524. The transmitter may transmit the L4 beam 524 using shallow search for LFS and FFS. If the beam quality of the L4 beam 524 is greater than or equal to the L4 beam threshold, the transmitter may perform an early exit as explained above. If the beam quality of the L4 beam 524 is less than the L4 beam threshold, the transmitter may transmit L2 beams 530 to continue the beam sweep process. The L2 beams 520 may be different than the L2 beams 530. In other words, the L2 beams 520 may not be the children beams of the best L1 beam. Here, the transmitter may transmit the L2 beams 530 using deep search for LFS because the L2 beams 530 are not the children beams of the best L1 beam. The transmitter may transmit the L2 beams 530 using deep search for FFS. If any of the beam qualities of the L2 beams 530 is greater than or equal to a L2 beam threshold associated with the L2 beams 530, the transmitter may perform an early exit as explained above. If the beam qualities of the L2 beams 530 are less than the L2 beam threshold, the transmitter may provide the beam qualities information of the L2 beams 530, and optionally one or more of the beam qualities information of the L4 beams 522, 524, to the predictor 550. The predictor 550 may generate a L4 beam configuration associated with a L4 beam 532 based on the beam qualities of at least the L2 beams 530.

In an aspect of the present disclosure, the transmitter may transmit the L4 beam 534. The transmitter may transmit the L4 beams 534 using shallow search for LFS and FFS. If the beam quality of the L4 beam 534 is greater than or equal to the L4 beam threshold, the transmitter may perform an early exit as explained above. If the beam quality of the L4 beam 534 is less than the L4 beam threshold, the transmitter may transmit additional L2 beams (different than the L2 beams 520, 530) and iteratively repeat the process above to search for a suitable beam.

In some aspects of the present disclosure, the predictor 550 may receive inputs relating to L1 beams, L2 beams, L3 beams, and/or L4 beams. Specifically, the predictor 550 may receive beam configurations and qualities for various beams. Based on the received information, the predictor 550 may utilize one or more internal models and/or neural networks to predict a beam (such as a L4 beam) that has the best beam quality.

In the second beam sweep scheme 500 described above, the transmitter transmits the L1 beams with a shallow search and the L2 beams using either a shallow search or a deep search. However, aspects of the present disclosure may include the transmitter transmitting the L1 beams with a deep search. Further, aspects of the present disclosure may include the transmitter transmitting the L2 beams with all deep searches, all shallow searches, or any combination thereof. The transmitter may utilize shallow searches for the predicted L4 beams, and/or the children of the best L1 beams.

In another aspect of the present disclosure, L3 beams may be predicted by the predictor instead of the L4 beams as described above. For example, the transmitter may provide the beam qualities information of the L1 beams 510 to the predictor 550. The predictor 550 may generate a first L3 beam configuration associated with a first L3 beam (not shown) instead of the L4 beam 512, based on the beam qualities of the L1 beams 510. Further, the transmitter may provide the beam qualities information of the L1 beams 510 and the first L3 beam to the predictor 550. The predictor 550 may generate a second L3 beam configuration associated with a second L3 beam (not shown) instead of the L4 beam 514, based on the beam qualities of the L1 beams 510 and the first L3 beam.

Similarly, in an aspect of the present disclosure, the transmitter may provide the beam qualities information of the L2 beams 520 to the predictor 550. The predictor 550 may generate a third L3 beam configuration associated with a third L3 beam (not shown) instead of the L4 beam 522, based on the beam qualities of the L2 beams 520. Further, the transmitter may provide the beam qualities information of the L2 beams 520 and the third L3 beam to the predictor 550. The predictor 550 may generate a fourth L3 beam configuration associated with a fourth L3 beam (not shown) instead of the L4 beam 424, based on the beam qualities of the L2 beams 520 and the third L3 beam.

Other beam prediction schemes may also be implemented according to various aspects of the present disclosure. For example, the predictor 550 may predict both L3 and L4 beams. In another example, the predictor 550 may utilize the beam qualities information of L3 and/or L4 beams to perform beam prediction for L3 and/or L4 beams.

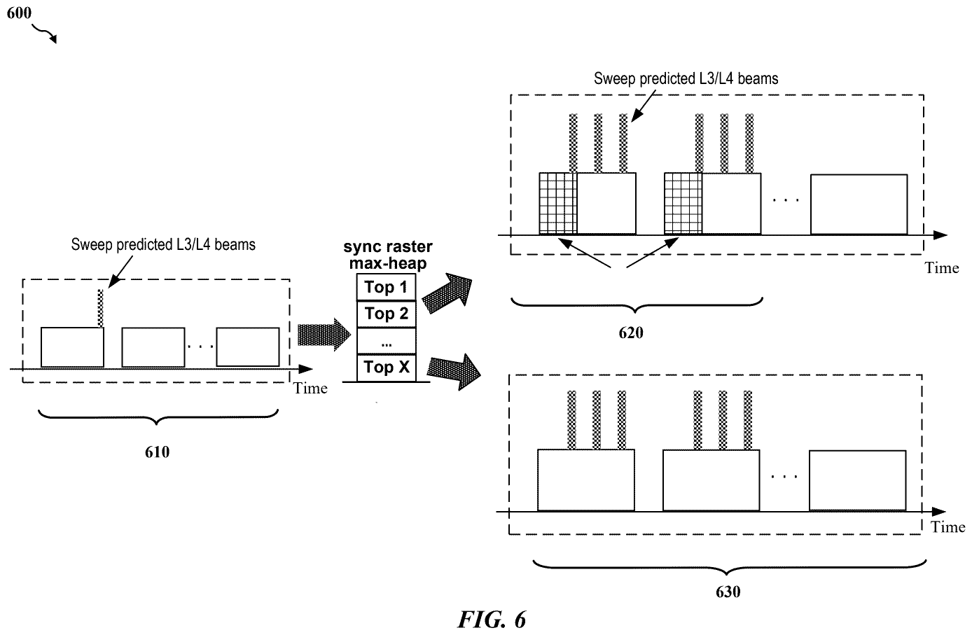

FIG. 6 is a block diagram of a beam sweep scheme 600 using LFS according to some aspects of the present disclosure. The transmitter may first transmit L1 beams 610 using shallow searches. For example, the transmitter may transmit 7 L1 beams. Next, the transmitter may generate a sync raster heap that sorts the L1 beams based on qualities. The heap may order the L1 beam with the highest quality (e.g., highest RSRP, lowest SNR, etc.) at the top of the heap. The transmitter may identify the top “x” raster, where “x” is an integer greater than 1.

In some aspects, the transmitter may transmit a first L2 beam set 620. If the current cell and frequency bin in L2 LFS are in the top “x” raster, the transmitter may perform shallow searches for the predicted L4 beams and the first L2 beam set 620. Otherwise, the transmitter may transmit the remaining L2 beam sets 630 using deep searches. The L4 beams may be performed using shallow searches for all the LFS.

Alternatively or additionally, in some aspects of the present disclosure, the transmitter may perform shallow and/or deep searches for predicted L3 beams using LFS as described above.

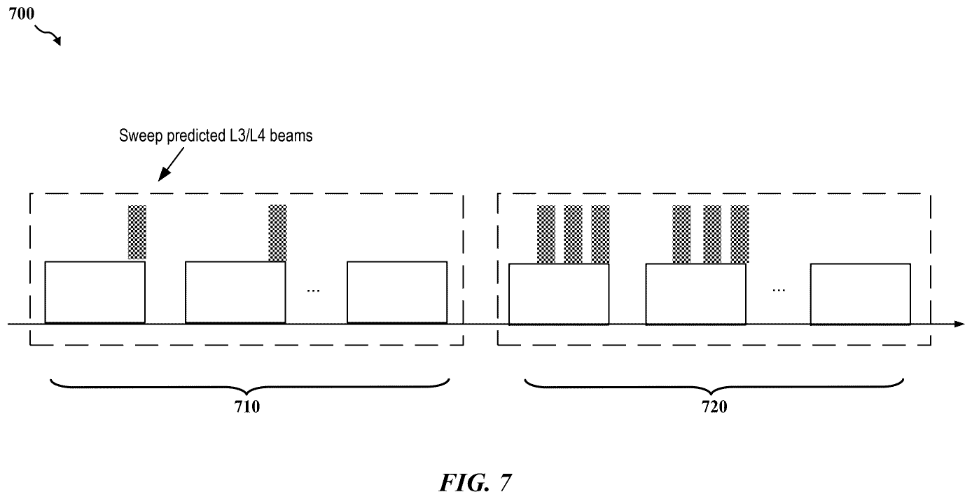

FIG. 7 is a block diagram of a beam sweep scheme 700 using FFS according to some aspects of the present disclosure. The transmitter may transmit L1 beams 710 using shallow searches. Next, the transmitter may transmit groups of L2 beams 720 using deep searches. The transmitter may transmit predicted L4 beams using shallow searches.

Alternatively or additionally, in some aspects of the present disclosure, the transmitter may perform shallow and/or deep searches for predicted L3 beams using FFS as described above.

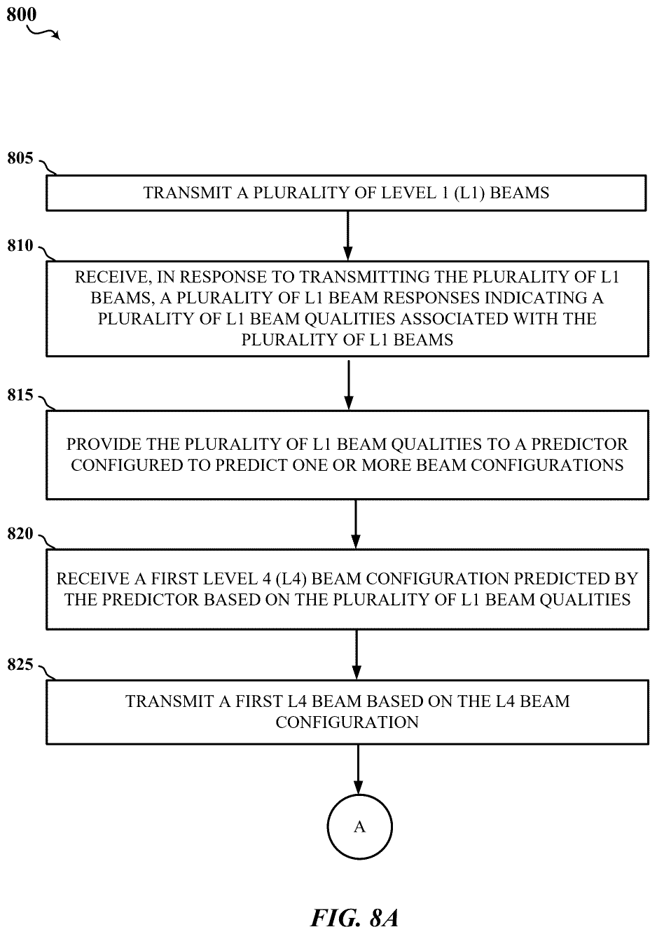

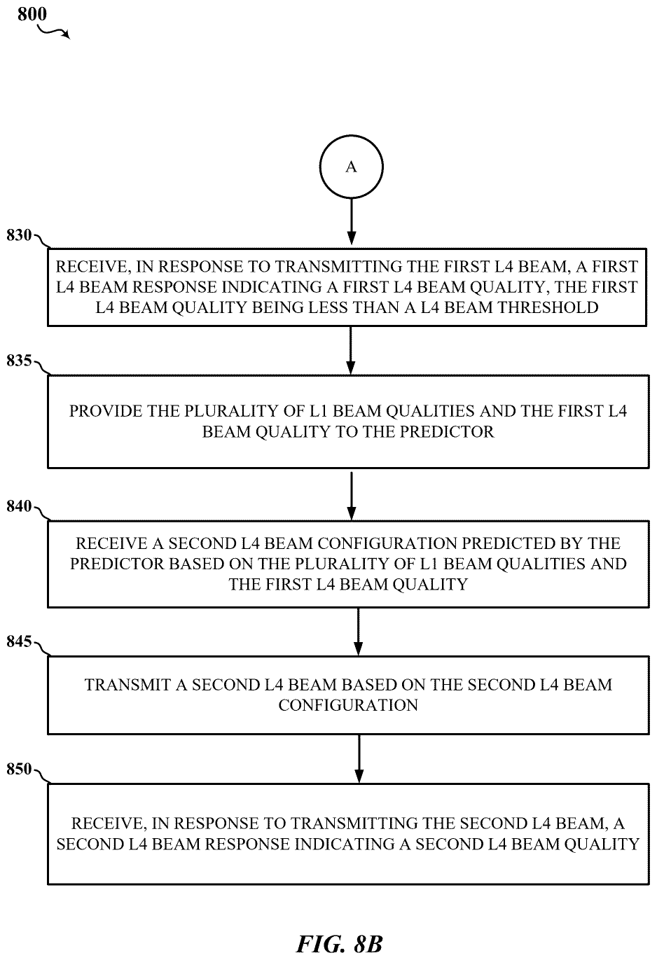

FIGS. 8A and 8B are a flow diagram of a method of performing beam sweep according to aspects of the present disclosure. The method 800 may be performed by one or more of the one or more processors 312, the one or more memories 316, the applications 375, the modem 320, the transceiver 302, the receiver 306, the transmitter 308, the RF front end 388, the communication component 322, the determination component 324, and/or one or more other components of the BS 105 in the wireless communication network 100.

At block 805, the method 800 may include transmitting a plurality of level 1 (L1) beams. For example, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may transmit a plurality of level 1 (L1) beams as described above.

In certain implementations, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may be configured to and/or may define means for transmitting a plurality of level 1 (L1) beams.

At block 810, the method 800 may include receiving, in response to transmitting the plurality of L1 beams, a plurality of L1 beam responses indicating a plurality of L1 beam qualities associated with the plurality of L1 beams. For example, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may receive, in response to transmitting the plurality of L1 beams, a plurality of L1 beam responses indicating a plurality of L1 beam qualities associated with the plurality of L1 beams as described above.

In certain implementations, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may be configured to and/or may define means for receiving, in response to transmitting the plurality of L1 beams, a plurality of L1 beam responses indicating a plurality of L1 beam qualities associated with the plurality of L1 beams.

At block 815, the method 800 may include providing the plurality of L1 beam qualities to a predictor configured to predict one or more beam configurations. For example, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may provide the plurality of L1 beam qualities to a predictor configured to predict one or more beam configurations as described above.

In certain implementations, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may be configured to and/or may define means for providing the plurality of L1 beam qualities to a predictor configured to predict one or more beam configurations.

At block 820, the method 800 may include receiving a first level 4 (L4) beam configuration predicted by the predictor based on the plurality of L1 beam qualities. For example, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may receive a first level 4 (L4) beam configuration predicted by the predictor based on the plurality of L1 beam qualities as described above.

In certain implementations, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may be configured to and/or may define means for receiving a first level 4 (L4) beam configuration predicted by the predictor based on the plurality of L1 beam qualities.

At block 825, the method 800 may include transmitting a first L4 beam based on the L4 beam configuration. For example, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may transmit a first L4 beam based on the L4 beam configuration as described above.

In certain implementations, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may be configured to and/or may define means for transmitting a first L4 beam based on the L4 beam configuration.

At block 830, the method 800 may include receiving, in response to transmitting the first L4 beam, a first L4 beam response indicating a first L4 beam quality, the first L4 beam quality being less than a L4 beam threshold. For example, the communication component 322, the determination component 324, the transceiver 302, the receiver 306, the transmitter 308, the RF front end 388, the subcomponents of the RF front end 388, the one or more processors 312, the one or more memories 316, the modem 320, and/or the applications 375 of the BS 105 may receive, in response to transmitting the first L4 beam, a first L4 beam response indicating a first L4 beam quality, the first L4 beam quality being less than a L4 beam threshold as described above.

In certain implementations, the communication component 322, the determination component 324, the transceiver 302, the receiver 306, the transmitter 308, the RF front end 388, the subcomponents of the RF front end 388, the one or more processors 312, the one or more memories 316, the modem 320, and/or the applications 375 of the BS 105 may be configured to and/or may define means for receiving, in response to transmitting the first L4 beam, a first L4 beam response indicating a first L4 beam quality, the first L4 beam quality being less than a L4 beam threshold.

At block 835, the method 800 may include providing the plurality of L1 beam qualities and the first L4 beam quality to the predictor. For example, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may provide the plurality of L1 beam qualities and the first L4 beam quality to the predictor as described above.

In certain implementations, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may be configured to and/or may define means for providing the plurality of L1 beam qualities and the first L4 beam quality to the predictor.

At block 840, the method 800 may include receiving a second L4 beam configuration predicted by the predictor based on the plurality of L1 beam qualities and the first L4 beam quality. For example, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may receive a second L4 beam configuration predicted by the predictor based on the plurality of L1 beam qualities and the first L4 beam quality as described above.

In certain implementations, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may be configured to and/or may define means for receiving a second L4 beam configuration predicted by the predictor based on the plurality of L1 beam qualities and the first L4 beam quality.

At block 845, the method 800 may include transmitting a second L4 beam based on the second L4 beam configuration. For example, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may transmit a second L4 beam based on the second L4 beam configuration as described above.

In certain implementations, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may be configured to and/or may define means for transmitting a second L4 beam based on the second L4 beam configuration.

At block 850, the method 800 may include receiving, in response to transmitting the second L4 beam, a second L4 beam response indicating a second L4 beam quality. For example, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may receive, in response to transmitting the second L4 beam, a second L4 beam response indicating a second L4 beam quality as described above.

In certain implementations, the communication component 322, the transceiver 302, the receiver 306, the transmitter 308, the RF front end 388, the subcomponents of the RF front end 388, the one or more processors 312, the one or more memories 316, the modem 320, and/or the applications 375 of the BS 105 may be configured to and/or may define means for receiving, in response to transmitting the second L4 beam, a second L4 beam response indicating a second L4 beam quality.

Aspects of the present disclosure include methods for performing beam sweep including transmitting a plurality of level 1 (L1) beams, receiving, in response to transmitting the plurality of L1 beams, a plurality of L1 beam responses indicating a plurality of L1 beam qualities associated with the plurality of L1 beams, providing the plurality of L1 beam qualities to a predictor configured to predict one or more beam configurations, receiving a first level 4 (L4) beam configuration predicted by the predictor based on the plurality of L1 beam qualities, transmitting a first L4 beam based on the L4 beam configuration, receiving, in response to transmitting the first L4 beam, a first L4 beam response indicating a first L4 beam quality, the first L4 beam quality being less than a L4 beam threshold, providing the plurality of L1 beam qualities and the first L4 beam quality to the predictor, receiving a second L4 beam configuration predicted by the predictor based on the plurality of L1 beam qualities and the first L4 beam quality, transmitting a second L4 beam based on the second L4 beam configuration, and receiving, in response to transmitting the second L4 beam, a second L4 beam response indicating a second L4 beam quality.

Aspects of the present disclosure include the method above, wherein transmitting the plurality of L1 beams comprises transmitting one synchronization signal block for repetitive physical synchronization signal detection and one synchronization signal block for physical broadcast channel decoding for each of a plurality of L1 beam configurations associated with the plurality of L1 beams.

Aspects of the present disclosure include any of the methods above, wherein transmitting the first L4 beam and the second L4 beam comprises transmitting one synchronization signal block for repetitive physical synchronization signal detection and one synchronization signal block for physical broadcast channel decoding for each of the first L4 beam configuration and the second L4 beam configuration.

Aspects of the present disclosure include any of the methods above, further comprising, in response to the second L4 beam quality being above the L4 beam threshold, initiating a physical random access channel procedure based on at least the second L4 beam, or in response to the second L4 beam quality being below the L4 beam threshold, transmitting a first plurality of L2 beams associated with a L1 beam of the plurality of L1 beams having a L1 beam quality higher than remaining L1 beam qualities of the plurality L1 beam qualities and receiving, in response to transmitting the first plurality of L2 beams, a first plurality of L2 beam responses indicating a first plurality of L2 beam qualities associated with the first plurality of L2 beams.

Aspects of the present disclosure include any of the methods above, wherein transmitting the first plurality of L2 beams comprises transmitting at least one synchronization signal block for repetitive physical synchronization signal detection and at least one synchronization signal block for physical broadcast channel decoding for each of a first plurality of L2 beam configurations associated with the first plurality of L2 beams.

Aspects of the present disclosure include any of the methods above, further comprising, in response to a first L2 beam quality of the first plurality of L2 beam qualities being above a L2 beam threshold, initiating a physical random access channel procedure based on at least the first L2 beam and the L1 beam, or in response to each of the first plurality of L2 beam qualities being less than a L2 beam threshold, providing the first plurality of L2 beam qualities to the predictor, receiving a third L4 beam configuration predicted by the predictor based on the first plurality of L2 beam qualities, transmitting a third L4 beam based on the third L4 beam configuration, and receiving, in response to transmitting the third L4 beam, a third L4 beam response indicating a third L4 beam quality.

Aspects of the present disclosure include any of the methods above, further comprising, in response to the third L4 beam quality being above the L4 beam threshold, initiating a physical random access channel procedure or in response to the third L4 beam quality being below the L4 beam threshold, providing the first plurality of L2 beam qualities and the third L4 beam quality to the predictor, receiving a fourth L4 beam configuration predicted by the predictor based on the first plurality of L2 beam qualities and the third L4 beam quality, transmitting a fourth L4 beam based on the fourth L4 beam configuration, and receiving, in response to transmitting the fourth L4 beam, a fourth L4 beam response indicating a fourth L4 beam quality.

Aspects of the present disclosure include any of the methods above, further comprising, in response to the fourth L4 beam quality being above the L4 beam threshold, initiating a physical random access channel procedure based on at least the L4 beam, or in response to the fourth L4 beam quality being below the L4 beam threshold, transmitting a second plurality of L2 beams different than the first plurality of L2 beams and receiving, in response to transmitting the second plurality of L2 beams, a second plurality of L2 beam responses indicating a second plurality of L2 beam qualities associated with the second plurality of L2 beams.

Aspects of the present disclosure include any of the methods above, further comprising, in response to a second L2 beam quality of the second plurality of L2 beam qualities being above the L2 beam threshold, initiating a physical random access channel procedure based on at least the second L2 beam, or in response to each of the second plurality of L2 beam qualities being below the L2 beam threshold, providing the second plurality of L2 beam qualities to the predictor, receiving a fifth L4 beam configuration predicted by the predictor based on the second plurality of L2 beam qualities, transmitting a fifth L4 beam based on the fifth L4 beam configuration, and receiving, in response to transmitting the fifth L4 beam, a fifth L4 beam response indicating a fifth L4 beam quality.

Aspects of the present disclosure include any of the methods above, further comprising, in response to the fifth L4 beam quality being above the L4 beam threshold, initiating a physical random access channel procedure, or in response to the fifth L4 beam quality being below the L4 beam threshold, providing the second plurality of L2 beam qualities and the fifth L4 beam quality to the predictor, receiving a sixth L4 beam configuration predicted by the predictor based on the second plurality of L2 beam qualities and the fifth L4 beam quality, and transmitting a sixth L4 beam based on the sixth L4 beam configuration.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA 2000 1X, 1X, etc. IS-856 (TIA-856) is commonly referred to as CDMA 2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of wireless communication, comprising:
transmitting a plurality of level 1 (L1) beams;
receiving, in response to transmitting the plurality of L1 beams, a plurality of L1 beam responses indicating a plurality of L1 beam qualities associated with the plurality of L1 beams;
providing the plurality of L1 beam qualities to a predictor configured to predict one or more beam configurations;
receiving a first level 4 (L4) beam configuration predicted by the predictor based on the plurality of L1 beam qualities;
transmitting a first L4 beam based on the L4 beam configuration;
receiving, in response to transmitting the first L4 beam, a first L4 beam response indicating a first L4 beam quality, the first L4 beam quality being less than a L4 beam threshold;
providing the plurality of L1 beam qualities and the first L4 beam quality to the predictor;
receiving a second L4 beam configuration predicted by the predictor based on the plurality of L1 beam qualities and the first L4 beam quality;
transmitting a second L4 beam based on the second L4 beam configuration; and
receiving, in response to transmitting the second L4 beam, a second L4 beam response indicating a second L4 beam quality.

2. The method of claim 1, wherein transmitting the plurality of L1 beams comprises transmitting one synchronization signal block for repetitive physical synchronization signal detection and one synchronization signal block for physical broadcast channel decoding for each of a plurality of L1 beam configurations associated with the plurality of L1 beams.

3. The method of claim 1, wherein transmitting the first L4 beam and the second L4 beam comprises transmitting one synchronization signal block for repetitive physical synchronization signal detection and one synchronization signal block for physical broadcast channel decoding for each of the first L4 beam configuration and the second L4 beam configuration.

4. The method of claim 1, further comprising:
in response to the second L4 beam quality being greater than or equal to the L4 beam threshold:
initiating a physical random access channel procedure based on at least the second L4 beam; or
in response to the second L4 beam quality being less than the L4 beam threshold:
transmitting a first plurality of L2 beams associated with a L1 beam of the plurality of L1 beams having a L1 beam quality higher than remaining L1 beam qualities of the plurality L1 beam qualities; and
receiving, in response to transmitting the first plurality of L2 beams, a first plurality of L2 beam responses indicating a first plurality of L2 beam qualities associated with the first plurality of L2 beams.

5. The method of claim 4, wherein transmitting the first plurality of L2 beams comprises transmitting at least one synchronization signal block for repetitive physical synchronization signal detection and at least one synchronization signal block for physical broadcast channel decoding for each of a first plurality of L2 beam configurations associated with the first plurality of L2 beams.

6. The method of claim 4, further comprising:
in response to a first L2 beam quality of the first plurality of L2 beam qualities being greater than or equal to a L2 beam threshold:
initiating a physical random access channel procedure based on at least the first L2 beam and the L1 beam; or
in response to each of the first plurality of L2 beam qualities being less than a L2 beam threshold:
providing the first plurality of L2 beam qualities to the predictor;
receiving a third L4 beam configuration predicted by the predictor based on the first plurality of L2 beam qualities;
transmitting a third L4 beam based on the third L4 beam configuration; and
receiving, in response to transmitting the third L4 beam, a third L4 beam response indicating a third L4 beam quality.

7. The method of claim 6, further comprising:
in response to the third L4 beam quality being greater than or equal to the L4 beam threshold:
initiating a physical random access channel procedure; or
in response to the third L4 beam quality being less than the L4 beam threshold:
providing the first plurality of L2 beam qualities and the third L4 beam quality to the predictor;
receiving a fourth L4 beam configuration predicted by the predictor based on the first plurality of L2 beam qualities and the third L4 beam quality;
transmitting a fourth L4 beam based on the fourth L4 beam configuration; and
receiving, in response to transmitting the fourth L4 beam, a fourth L4 beam response indicating a fourth L4 beam quality.

8. The method of claim 7, further comprising:
in response to the fourth L4 beam quality being greater than or equal to the L4 beam threshold:
initiating a physical random access channel procedure based on at least the L4 beam; or
in response to the fourth L4 beam quality being less than the L4 beam threshold:
transmitting a second plurality of L2 beams different than the first plurality of L2 beams; and
receiving, in response to transmitting the second plurality of L2 beams, a second plurality of L2 beam responses indicating a second plurality of L2 beam qualities associated with the second plurality of L2 beams.

9. The method of claim 8, further comprising:
in response to a second L2 beam quality of the second plurality of L2 beam qualities being greater than or equal to the L2 beam threshold:
initiating a physical random access channel procedure based on at least the second L2 beam; or
in response to each of the second plurality of L2 beam qualities being less than the L2 beam threshold:
providing the second plurality of L2 beam qualities to the predictor;
receiving a fifth L4 beam configuration predicted by the predictor based on the second plurality of L2 beam qualities;
transmitting a fifth L4 beam based on the fifth L4 beam configuration; and
receiving, in response to transmitting the fifth L4 beam, a fifth L4 beam response indicating a fifth L4 beam quality.

10. The method of claim 9, further comprising:
in response to the fifth L4 beam quality being greater than or equal to the L4 beam threshold:
initiating a physical random access channel procedure; or
in response to the fifth L4 beam quality being less than the L4 beam threshold:
providing the second plurality of L2 beam qualities and the fifth L4 beam quality to the predictor;
receiving a sixth L4 beam configuration predicted by the predictor based on the second plurality of L2 beam qualities and the fifth L4 beam quality; and
transmitting a sixth L4 beam based on the sixth L4 beam configuration.

11. A transmitter, comprising:
one or more memories configured to store executable instructions;
one or more processors communicatively coupled to the one or more memories and configured to execute the stored executable instructions to:
transmit a plurality of level 1 (L1) beams;
receive, in response to transmitting the plurality of L1 beams, a plurality of L1 beam responses indicating a plurality of L1 beam qualities associated with the plurality of L1 beams;
provide the plurality of L1 beam qualities to a predictor configured to predict one or more beam configurations;
receive a first level 4 (L4) beam configuration predicted by the predictor based on the plurality of L1 beam qualities;
transmit a first L4 beam based on the L4 beam configuration;
receive, in response to transmitting the first L4 beam, a first L4 beam response indicating a first L4 beam quality, the first L4 beam quality being less than a L4 beam threshold;
provide the plurality of L1 beam qualities and the first L4 beam quality to the predictor;
receive a second L4 beam configuration predicted by the predictor based on the plurality of L1 beam qualities and the first L4 beam quality;
transmit a second L4 beam based on the second L4 beam configuration; and
receive, in response to transmitting the second L4 beam, a second L4 beam response indicating a second L4 beam quality.

12. The transmitter of claim 11, wherein the one or more processors are further configured to transmit the plurality of L1 beams by transmitting one synchronization signal block for repetitive physical synchronization signal detection and one synchronization signal block for physical broadcast channel decoding for each of a plurality of L1 beam configurations associated with the plurality of L1 beams.

13. The transmitter of claim 11, wherein the one or more processors are further configured to transmit the first L4 beam and the second L4 beam by transmitting one synchronization signal block for repetitive physical synchronization signal detection and one synchronization signal block for physical broadcast channel decoding for each of the first L4 beam configuration and the second L4 beam configuration.

14. The transmitter of claim 11, wherein the one or more processors are further configured to:
in response to the second L4 beam quality being above the L4 beam threshold:
initiate a physical random access channel procedure based on at least the second L4 beam; or
in response to the second L4 beam quality being below the L4 beam threshold:
transmitting a first plurality of L2 beams associated with a L1 beam of the plurality of L1 beams having a L1 beam quality higher than remaining L1 beam qualities of the plurality L1 beam qualities; and
receiving, in response to transmitting the first plurality of L2 beams, a first plurality of L2 beam responses indicating a first plurality of L2 beam qualities associated with the first plurality of L2 beams.

15. The transmitter of claim 14, wherein the one or more processors are further configured to transmit the first plurality of L2 beams by transmitting at least one synchronization signal block for repetitive physical synchronization signal detection and at least one synchronization signal block for physical broadcast channel decoding for each of a first plurality of L2 beam configurations associated with the first plurality of L2 beams.

16. The transmitter of claim 14, wherein the one or more processors are further configured to:
in response to a first L2 beam quality of the first plurality of L2 beam qualities being above a L2 beam threshold:
initiate a physical random access channel procedure based on at least the first L2 beam and the L1 beam; or
in response to each of the first plurality of L2 beam qualities being less than a L2 beam threshold:
provide the first plurality of L2 beam qualities to the predictor;
receive a third L4 beam configuration predicted by the predictor based on the first plurality of L2 beam qualities;
transmit a third L4 beam based on the third L4 beam configuration;
receive, in response to transmitting the third L4 beam, a third L4 beam response indicating a third L4 beam quality.

17. The transmitter of claim 16, wherein the one or more processors are further configured to:
in response to the third L4 beam quality being above the L4 beam threshold:
initiate a physical random access channel procedure; or
in response to the third L4 beam quality being below the L4 beam threshold:
provide the first plurality of L2 beam qualities and the third L4 beam quality to the predictor;
receive a fourth L4 beam configuration predicted by the predictor based on the first plurality of L2 beam qualities and the third L4 beam quality;
transmit a fourth L4 beam based on the fourth L4 beam configuration; and
receive, in response to transmitting the fourth L4 beam, a fourth L4 beam response indicating a fourth L4 beam quality.

18. The transmitter of claim 17, wherein the one or more processors are further configured to:
in response to the fourth L4 beam quality being above the L4 beam threshold:
initiate a physical random access channel procedure based on at least the L4 beam; or
in response to the fourth L4 beam quality being below the L4 beam threshold:
transmit a second plurality of L2 beams different than the first plurality of L2 beams; and
receive, in response to transmitting the second plurality of L2 beams, a second plurality of L2 beam responses indicating a second plurality of L2 beam qualities associated with the second plurality of L2 beams.

19. The transmitter of claim 18, wherein the one or more processors are further configured to:
in response to a second L2 beam quality of the second plurality of L2 beam qualities being above the L2 beam threshold:
initiate a physical random access channel procedure based on at least the second L2 beam; or
in response to each of the second plurality of L2 beam qualities being below the L2 beam threshold:
provide the second plurality of L2 beam qualities to the predictor;
receive a fifth L4 beam configuration predicted by the predictor based on the second plurality of L2 beam qualities;
transmit a fifth L4 beam based on the fifth L4 beam configuration;
receive, in response to transmitting the fifth L4 beam, a fifth L4 beam response indicating a fifth L4 beam quality.

20. A transmitter, comprising:
means for transmitting a plurality of level 1 (L1) beams;
means for receiving, in response to transmitting the plurality of L1 beams, a plurality of L1 beam responses indicating a plurality of L1 beam qualities associated with the plurality of L1 beams;
means for providing the plurality of L1 beam qualities to a predictor configured to predict one or more beam configurations;
means for receiving a first level 4 (L4) beam configuration predicted by the predictor based on the plurality of L1 beam qualities;
means for transmitting a first L4 beam based on the L4 beam configuration;
means for receiving, in response to transmitting the first L4 beam, a first L4 beam response indicating a first L4 beam quality, the first L4 beam quality being less than a L4 beam threshold;
means for providing the plurality of L1 beam qualities and the first L4 beam quality to the predictor;
means for receiving a second L4 beam configuration predicted by the predictor based on the plurality of L1 beam qualities and the first L4 beam quality;
means for transmitting a second L4 beam based on the second L4 beam configuration; and
means for receiving, in response to transmitting the second L4 beam, a second L4 beam response indicating a second L4 beam quality.
